(19) United States
(12) Patent Application Publication
(10) Pub. No.: US 2022/0100250 A1
(43) Pub. Date: Mar. 31, 2022

(54) DATACENTER POWER MANAGEMENT WITH EDGE MEDIATION BLOCK

(71) Applicant: Virtual Power Systems Inc., Milpitas, CA (US)

(72) Inventors: Karimulla Raja Shaikh, Cupertino, CA (US); Andrey Ilinykh, Walnut Creek, CA (US)

(73) Assignee: Virtual Power Systems Inc., Milpitas, CA (US)

(21) Appl. No.: 17/489,608

(22) Filed: Sep. 29, 2021

Related U.S. Application Data
(60) Provisional application No. 63/084,597, filed on Sep. 29, 2020.

(51) Int. Cl. G06F 1/3203; H02J 13/00

(52) U.S. Cl. CPC G06F 1/3203; H02J 13/00032

(57) ABSTRACT

Datacenter power management using edge mediation is disclosed. A datacenter power policy is provided to a centralized power management platform. The policy oversees a datacenter topology that includes energy control blocks. Each of the energy control blocks comprises an energy control block coupled to one or more datacenter loads. A power control gateway is coupled between the centralized power management platform and the one or more of energy control blocks. The power control gateway comprises one gateway element for each of the one or more energy control blocks. Each gateway element includes a policy execution component, a sensor data exchange component, a data summarization component, and a global state analysis component. Sensor data from the energy control blocks is summarized and forwarded to the centralized power management platform. Power distribution to the one or more datacenter loads is controlled using inter-gateway element information distributed among each gateway element.

### CROSS-REFERENCE TO RELATED PATENT APPLICATIONS

This application claims priority to U.S. Provisional Patent Application No. 63/084,597 entitled “DATACENTER POWER MANAGEMENT WITH EDGE MEDIATION BLOCK” filed Sep. 29, 2020 which is incorporated herein by reference in its entirety.

### FIELD OF ART

This application relates generally to power management and more particularly to datacenter power management with edge mediation block.

### BACKGROUND

Resources such as computing resources are critical to the operation or even the continued existence of organizations, agencies, and enterprises. Irrespective of the type of entity, be it a financial institution, healthcare provider, insurer, government agency, research institution, or corporation, among many others, high availability or “HA” environments, contracted services, and service level agreements dictate that the access to computing resources is reliable and consistent, 24×7×365. The data that is processed by these computing resources is often deemed the most valuable asset of any of these entities, so the data must be secured and access to the data must be tightly restricted. To both enable secure data access and support efficient processing of the data, the entities construct, support, and maintain large datacenters. These datacenters, sometimes called “server farms” because of the processors housed there, directly support the compute-intensive operations of the entities. Some of the datacenters are colocated with the organizations that operate them. Datacenters may also be remotely located or distributed to protect against disasters. Other datacenters are referred to as “lights out” datacenters. This latter class of datacenter is located remotely from the organization that operates it. The lights out datacenters are used to limit physical access to the equipment located within, to better control environmental conditions within the datacenter, and in some cases, to provide remote redundancy to an on-site datacenter. The redundancy is a typical portion of a disaster recovery plan.

The list of equipment within the datacenter typical includes servers, data storage and backup devices, communications equipment, networking equipment (switches), and other information technology (IT) equipment. In general, this network of heterogeneous systems is vital to the operation of the organization. The datacenter equipment is positioned in rows of data or IT racks. In additional to the processing, data handling, and communications equipment, the datacenter equipment further includes climate control equipment. While heating the datacenter is rarely required because of the prodigious heat generated by the IT equipment, cooling and humidity control are absolutely critical to safe and reliable equipment operation. A given organization uses the equipment within the datacenter to perform computational operations and to store, process, manage, and disseminate valuable data. Providing power to the equipment is a particularly difficult challenge because of the large and changeable power requirements of the datacenter. Some of the systems in the datacenter have more stringent power and availability requirements than other systems. Thus, deployment and placement of equipment within a datacenter are critical design and implementation factors. The amount of power demanded by and allocated to the data racks is typically very large. Additionally, the power demanded by the equipment fluctuates based on specific business factors, such as the processing job mix and the time of day, month, or season. Thus, managing power, space, and cooling are paramount concerns. Successful datacenter power management is also desirable because energy savings within the datacenter directly translate to increased profit margins, reduced wear and tear on power sources and equipment, and reduced cooling costs.

The computer systems within the datacenter, which are assembled from circuit boards, mass storage devices, networking interfaces, and processors, all consume power. The systems' requirements for reliable and efficient power delivery are mission crucial. In many cases, the reliability and availability requirements of the datacenter infrastructure must meet or exceed statutory requirements dictated by local, state, and national governments. Additional statutory requirements describe standards for protecting customer data. These latter requirements must be upheld by financial institutions, healthcare organizations, educational organizations, and retail organizations. Some datacenters are under contractual obligations that mandate availability, reliability, job load, and other organizational demands. Generally, datacenter design requirements demand the provision of sufficient power to the equipment within the datacenter. Some datacenters such as HA datacenters typically require that power can be provided by more than one power grid to the datacenters. Power can be provided by a combination of a utility grid power and locally generated power. Regardless of how the power is provided, delivering reliable and efficient power is paramount.

### SUMMARY

Datacenter power management with edge mediation block is disclosed. A datacenter power policy is deployed to a centralized power management platform. The policy oversees a datacenter topology that includes one or more energy control blocks. Each of the one or more energy control blocks comprises an energy control block coupled to one or more datacenter loads. Datacenter loads can include processors, servers, networking, communications, and data storage equipment, HVAC, power conditioning, etc. A power control gateway is coupled between the centralized power management platform and the one or more energy control blocks. The power control gateway comprises one gateway element for each of the one or more energy control blocks. Power distribution to the one or more datacenter loads is controlled using inter-gateway element information distributed among each gateway element. Each gateway element includes a policy execution component, a sensor data exchange component, a data summarization component, and a global state analysis component.

Datacenter operation necessitates stringent power requirements for sourcing, storing, and distributing power. The datacenter power requirements can change substantially over time due to the quantity and variety of datacenter equipment; changes in positioning of datacenter racks; changes in cooling requirements; and other electrical, thermal, and deployment factors. Further power requirements are dependent on the mix or combination of the processing jobs. Power requirements are determined based on the loads driven, including AC and DC loads. For example, power requirements can increase during normal business hours, and decrease after-hours and/or on weekends or holidays. Furthermore, the makeup of AC load demand vs. DC load demand can change as equipment in the datacenter is added or swapped out. Less predictable or “soft” factors include scheduling various batch jobs and other processing tasks. The power requirement fluctuations can be influenced by required software or application activity, planned maintenance, unplanned events such as equipment failure, etc. In order to maintain datacenter service level agreements for power supply, reliability, and integrity, a global state of a datacenter topology can be sensed and analyzed.

A computer program product is disclosed. The computer program product is embodied in a non-transitory computer readable medium for power management, the computer program product comprising code which causes one or more processors to perform operations of: deploying a datacenter power policy to a centralized power management platform, wherein the policy oversees a datacenter topology that includes one or more energy control blocks, wherein each of the one or more energy control blocks comprises an energy control block coupled to one or more datacenter loads; coupling a power control gateway between the centralized power management platform and the one or more of energy control blocks, wherein the power control gateway comprises one gateway element for each of the one or more energy control blocks; and controlling power distribution to the one or more datacenter loads using inter-gateway element information distributed among each gateway element.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for datacenter power management with an edge mediation block.

FIG. 2 is a flow diagram for updating policy data.

FIG. 3 shows a topology for datacenter power management.

FIG. 4 illustrates a gateway functional architecture.

FIG. 5 shows a system for datacenter current injection.

FIG. 6 is a block diagram for a charger.

FIG. 7 is a block diagram for a single-phase inverter.

FIG. 8 illustrates pulse width modulation (PWM) of a sinusoid.

FIG. 9 shows a datacenter rack configuration.

FIG. 10 is a flow diagram for datacenter power management using current injection.

FIG. 11 is a system diagram for datacenter power management using an edge mediation block.

### DETAILED DESCRIPTION

This disclosure provides techniques for power management including datacenter power management with an edge mediation block. The management of the myriad information technology (IT) tasks associated with operating a datacenter is a highly complex and challenging. Among the most challenging IT tasks are the efficient and reliable distribution of power, space allocation for electrical equipment, and provisioning of cooling capacity. Datacenters pose particularly difficult resource management challenges because the supply of and demand for power must be carefully balanced. Some datacenters are designed for and dedicated to a single organization, while other datacenters provide contracted resources for use by multiple organizations. Use of a given datacenter by various organizations can be managed based on multiple factors. The factors can include the amount of equipment a given organization requires to locate in the datacenter, power load requirements, power source redundancy requirements such as 1N, 1N+1, or 2N redundancy, service level agreements (SLAs) and other contractual obligations for the power, etc.

Datacenter power systems are designed to meet the dynamic power needs of large installations of disparate electrical equipment. Various processing and other electrical equipment can be present in a datacenter, including servers, blade servers, communications switches, backup data storage units, communications hardware, and other processing and associated devices. The electrical equipment can include one or more of data servers; server racks; and heating, ventilating, and air conditioning (HVAC) units. The HVAC units are installed to manage humidity and the copious heat that is dissipated by all of the electrical equipment in the datacenter. The power systems receive power from multiple power feeds, where the coupled power feeds can include grid power such as hydro, wind, solar, nuclear, coal, or other power plants; local power generated from micro-hydro, wind, solar, geothermal, etc.; diesel-generator (DG) sets; and so on. The multiple power feeds, typically numbering at least two feeds, provide critical redundancy for and backup of power delivery to the datacenter power systems. So, if one power feed were to go down or be taken offline for maintenance, then another power feed can provide without interruption the dynamic power needed to drive the power loads of the datacenters. In modern datacenters, the IT infrastructure within a datacenter can be controlled by software. The use of software-defined IT infrastructures, such as compute, network, or storage infrastructures, supports flexible and automated management of datacenter power. Many different datacenter structures and business models can be enhanced by the techniques disclosed within, including enterprise datacenters, collocation datacenters, hyperscale datacenters, brownfield datacenters, greenfield datacenters, microgrid datacenters, modularized datacenters, cloud processing datacenters, and so on.

In disclosed techniques, datacenter power management is accomplished with an edge mediation block. A datacenter power policy is deployed to a centralized power management platform. The power policy can include a static power policy or a dynamic power policy. The power policy can be uploaded by a user such as a datacenter administrator, downloaded from a library of power policies, adapted from an existing power policy, and so on. The datacenter policy can be based on measured capacity, on anticipated power loads, on contractual agreements, on availability requirements, and so on. The policy oversees a datacenter topology that includes one or more energy control blocks. The datacenter topology can include at least one utility grid feed, one or more power caches, one or more power control blocks, one or more loads, one or more switches or smart switches, and one or more uninterruptible power supplies (UPSs), providing AC power. Each of the one or more energy control blocks comprises an energy control block coupled to one or more datacenter loads. The datacenter loads can include processors, servers, switches, data storage devices, communications equipment, HVAC equipment, etc. A power control gateway is coupled between the centralized power management platform and the one or more energy control blocks. The power control gateway can provide communications capabilities based on one or more communications protocols such as HTTP. The power control gateway can communicate with the power management platform and the power devices, whether the power devices can be controlled by the power policy or not. Two or more power control gateways can form a network such as a mesh network for inter-power control gateway communications. The power control gateway comprises one gateway element for each of the one or more energy control blocks. Power distribution to the one or more datacenter loads is controlled using inter-gateway element information distributed among each gateway element. The distributing the inter-gateway element information can be accomplished using the mesh network.

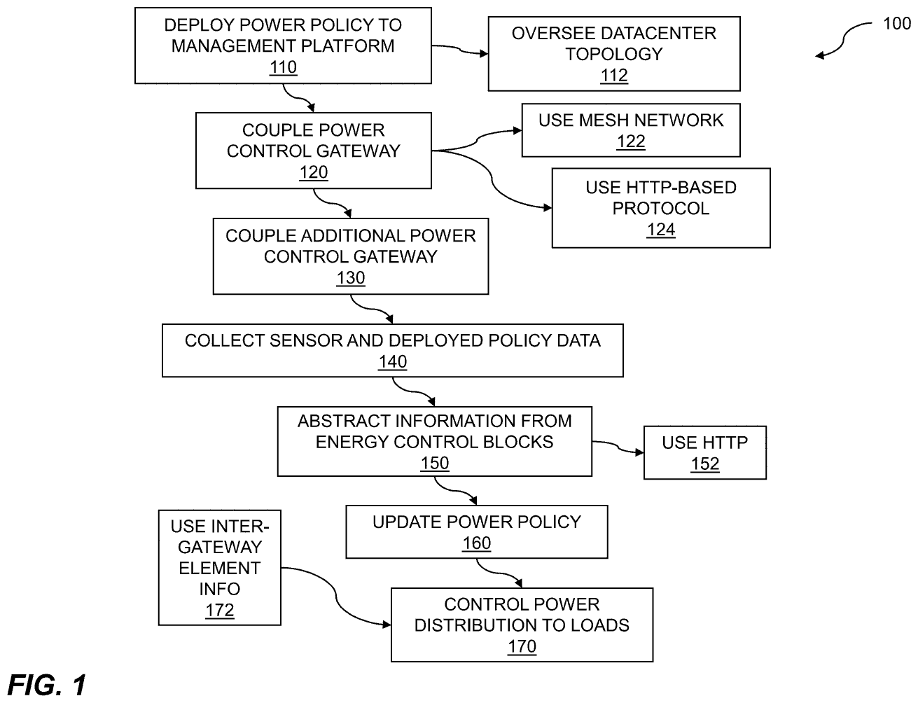

FIG. 1 is a flow diagram for datacenter power management with an edge mediation block. The flow diagram 100 is based on a computer-implemented method for power management. The flow 100 includes deploying a datacenter power policy 110 to a centralized power management platform. A datacenter houses processing equipment, networking equipment, data storage equipment, communications equipment, and the like. The datacenter further houses electrical equipment such as heating, ventilation, and air conditioning (HVAC) equipment, switches and smart switches, power caches than can include batteries or capacitors, uninterruptable power supplies (UPS), access to power sources such as grid, renewable, or microgrid power, access to backup power such as diesel-generator (DG) sets, and so on. The datacenter power policy can be used to configure the electrical equipment within the datacenter. The policy can be used to assign priorities to equipment such as high priorities or low priorities; to provide two or more power sources to equipment needed to meet high-availability requirements, etc. The policy can be based on one or more service level agreements (SLAs). In the flow 100, the policy oversees a datacenter topology 112 that includes one or more energy control blocks, where each of the one or more energy control blocks comprises an energy control block coupled to one or more datacenter loads. A datacenter topology is based on power sources, power switching settings, provision of power caches and UPSs, and so on. The energy control blocks can be used to control the providing of power to the one or more datacenter loads coupled to the energy control blocks. The power provided to the loads can include AC power, where the AC power can include one or more voltages; one or more phases; one or more frequencies; and the like. The power provided to the loads can include DC power, where the DC power can include one or more voltages. In other embodiments, the energy control blocks can include sets of energy control blocks coupled to the power control gateway. The energy control blocks can include energy control blocks that can be coupled to policy devices, non-policy devices, etc. The policy devices and the non-policy devices can include a variety of electrical equipment. In embodiments, the one or more energy control blocks can include energy conditioning devices or energy switching devices

The flow 100 includes coupling a power control gateway 120 between the centralized power management platform and the one or more of energy control blocks. The power control gateway can act as in intermediary between the centralized power management platform and the one or more datacenter loads by providing a variety of services to the platform and the loads. In embodiments, the one or more loads can include servers in a rack-mounted datacenter topology. The services can include communication services, management services, data services, execution services, data gathering services, and the like. The services can be provided using one or more components. In embodiments, each gateway element includes a policy execution component, a sensor data exchange component, a data summarization component, and a global state analysis component. In embodiments, the power control gateway comprises one gateway element for each of the one or more energy control blocks. In the flow 100, each element of the power control gateway is interconnected 122 using a mesh network. Within a mesh network, each element, such as each element within the power control gate, can communicate with other components without requiring that the communication be conducted through a higher-level component, system, or platform. In embodiments, the mesh network can enable each element of the power control gateway to communicate with each other element of the power control gateway independently from the centralized power management platform. Such interelement communication can offer one or more communications paths. Use of a particular communication path can be based on path speed, availability, and the like. In other embodiments, the energy control blocks can employ a heterogeneous set of communication protocols. The communications protocols can be based on TCP/IP, UDP, and the like. In the flow 100, the energy control gateway is coupled to the centralized power management platform using hypertext transfer protocol-based (HTTP-based) 124 communication. The HTTP-based communication can include a webpage, a web-based dashboard, a webapp, etc.

The flow 100 further includes coupling 130 an additional power control gateway. The additional power control gateway can be coupled to provide redundancy, to distribute loads across multiple gateways, to provide access to different types of devices such as non-policy devices, and the like. In embodiments, the additional power control gateway can be coupled between the centralized power management platform and an additional one or more energy control blocks. The additional one or more energy control blocks can each be coupled to one or more additional datacenter loads. In embodiments, the power control gateway and the additional power control gateway can be directly coupled to each other. The direct coupling can be based on a wired connection, a wireless connection, a hybrid wired and wireless connection, and so on. The direct coupling can enable communication between or among the power control gateways without requiring that such communications be routed through the centralized power management platform.

The flow 100 includes collecting 140 sensor data and currently deployed policy data from at least one of the one or more energy control blocks. The collected sensor data and currently deployed policy data can be analyzed, processed, stored, communicated, and so on. Embodiments include exchanging sensor data that was collected among each of the energy control blocks. The sensor that is exchanged can be compared with data collected locally to an energy control block. Further embodiments include providing the sensor data and currently deployed policy data that was collected to an application programming interface (API) for the power control gateway. Providing the collected data to an API can simplify communications between or among power control gateways, between a power control gateway and the centralized power management platform, etc. In other embodiments, at least one of the one or more energy control blocks can operate in a read-only mode. An energy control block operating in a read-only mode can provide status, condition, and other data, but may not receive data exchanged by other energy control blocks.

Recall that the power control gateway can process, analyze, manipulate, etc., the data. In embodiments, sensor data from the one or more energy control blocks can be summarized. Summarizing the data can include performing arithmetic, statistical, or other operations on the data. In embodiments, the sensor data that is summarized can be forwarded to the centralized power management platform. The centralized power management platform can use the summarized data to modify a deployed policy, to choose a different policy, etc. In other embodiments, the sensor data that is summarized can be forwarded to the one or more energy control blocks. The forwarding the summarized data to the energy control blocks can be accomplished using the mesh network or other network. The flow 100 further includes abstracting, by the power control gateway, information 150 from the one or more energy control blocks. The abstracting information from the energy control blocks can include enabling equipment status checks such as healthy or not healthy, online or offline, unresponsive or failed, etc. The abstracting can include metrics such as determining if the deployed policy is adequately meeting power requirements. In embodiments, the information that was abstracted can be forwarded to the centralized power management platform. The forwarding of the abstracted information can be accomplished using a variety of communications protocols. In the flow 100, the information that was abstracted can be forwarded using a hypertext transfer protocol 152 (HTTP). Various types of information can be abstracted from the collected information. In embodiments, the information that was abstracted can include energy control block form factor, sensor data, or non-policy-based energy control block identification, and so on. Other data such as state data can be aggregated. In embodiments, the power control gateway can enable a global state aggregation from each of the energy control blocks to be communicated to the centralized power management platform. The global state can comprise state information from loads, gateways, power control blocks, etc.

The flow 100 further includes updating 160 the currently deployed policy data using the power control gateway. A variety of techniques can be used to update the currently deployed policy. The policy can be modified by the centralized power management platform and deployed to the power control gateway. The power management platform could update the deployed policy by selecting a second policy and deploying the second policy. The power control gateway can update the deployed policy locally. The flow 100 includes controlling power distribution 170 to the one or more datacenter loads. The controlling power distribution can include controlling source power such as grid power, controlling switches to route power to loads, controlling power caches by enabling or disabling the caches, controlling UPSs by enabling or disabling the UPSs, etc. The controlling power distribution can be based on the datacenter topology. In the flow 100 the distribution is accomplished using inter-gateway element information 172 distributed among each gateway element. The inter-gateway element information can include mesh network information. The distribution can be based on one or more communication protocols such as TCP/IP, UDP, etc. In embodiments, the distribution is based on an HTTP-based protocol. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

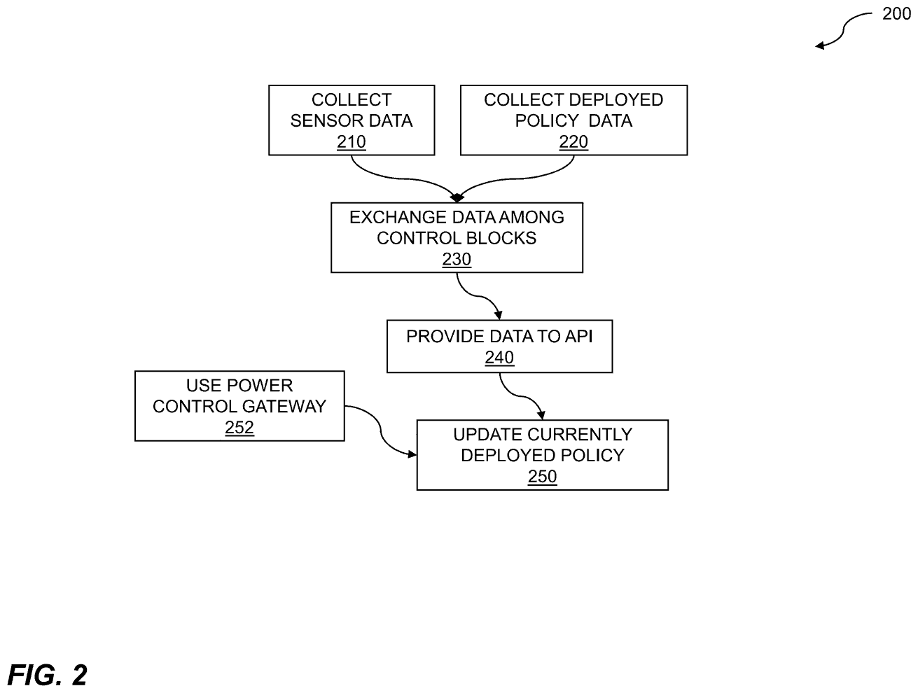

FIG. 2 is a flow diagram for updating policy data. A policy, such as a datacenter power policy, can be used to oversee a datacenter topology. The policy enables power to be provided to the various electrical components and devices such as servers within the datacenter. Since the amount of power required varies over time due to changes in job mix, processing priorities, availability levels, service levels, and so on, a policy that was chosen based power requirements of the loads at one point in time is not necessarily appropriate at a second point in time. The policy can be updated based on data. Updating policy such as a datacenter power policy enables datacenter power management with edge mediation block. A datacenter power policy is deployed to a centralized power management platform. A power control gateway is coupled between the centralized power management platform and the one or more energy control blocks. Power distribution to the one or more datacenter loads is controlled using inter-gateway element information distributed among each gateway element.

The flow 200 includes collecting sensor data 210 from at least one of the one or more energy control blocks. The sensor data can include current load data, operating temperature data, time since last shutdown or maintenance data, vibration data, and so on. The sensor data can be collected using a mesh network, where the mesh network can be based on a network of gateways (described below). The flow 200 includes collecting currently deployed policy data 220 from at least one of the one or more energy control blocks. The collected currently deployed policy data can include time since deployment, fidelity to power load requirements, time since power policy deployment, etc. The flow 200 includes exchanging sensor data 230 that was collected among each of the energy control blocks. The exchanging sensor data can be accomplished using the mesh network comprising the energy control blocks; a wired, wireless, or hybrid network; and so on. A variety of communications techniques can be used for the exchanging of sensor data. In embodiments, the exchanging sensor data is accomplished using a hypertext transfer protocol (HTTP).

The flow 200 includes providing the sensor data 240 and currently deployed policy data that was collected to an application programming interface (API) for the power control gateway. The API enables definition of interactions between modules such as software modules. The interactions can include calls to functions or procedures, requests such as processing requests, data formats for exchanging data, and the like. The great advantage of using an API is that interactions between modules is clearly defined and easily coded since detailed knowledge of the inner workings of the modules has been abstracted away. That is, detailed information about register sizes and formats, internal control signals, interrupt handling, and other low-level operations are hidden. Instead, the coder needs only to know about the requirements of communicating with the API.

The flow 200 further includes updating the currently deployed policy 250 data. The currently deployed policy can be updated to better track power requirements of devices or loads; to change availability levels such as changing from low-availability to high-availability or vice versa; to reflect changes in service level agreements; to make changes to accommodate expected processing load changes such as running monthly payroll; to reflect seasonal change requirements such as providing more cooling during hot months and less cooling during cold (or cooler) months, etc. The updating the currently deployed policy can include making changes to the currently deployed policy and redeploying the updated policy to the centralized power management platform; providing data such as the changed data to the one or more power control gateways, thus enabling changes to the datacenter topology; and so on. The flow 200 includes using the power control gateway 252. Discussed throughout, a power control gateway can be coupled between a centralized power management platform and one or more energy control blocks, where the energy control blocks can be coupled to one or more loads. Such changes can be executed when the energy control block and/or device can be operated in a read/write mode. A read/write mode can be supported by a device such as a policy device, where a policy device can be managed by the centralized power management platform. Other devices can include “non-policy” devices. These latter devices may not be manageable by the power management platform. In embodiments, at least one of the one or more energy control blocks operates in a read-only mode. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

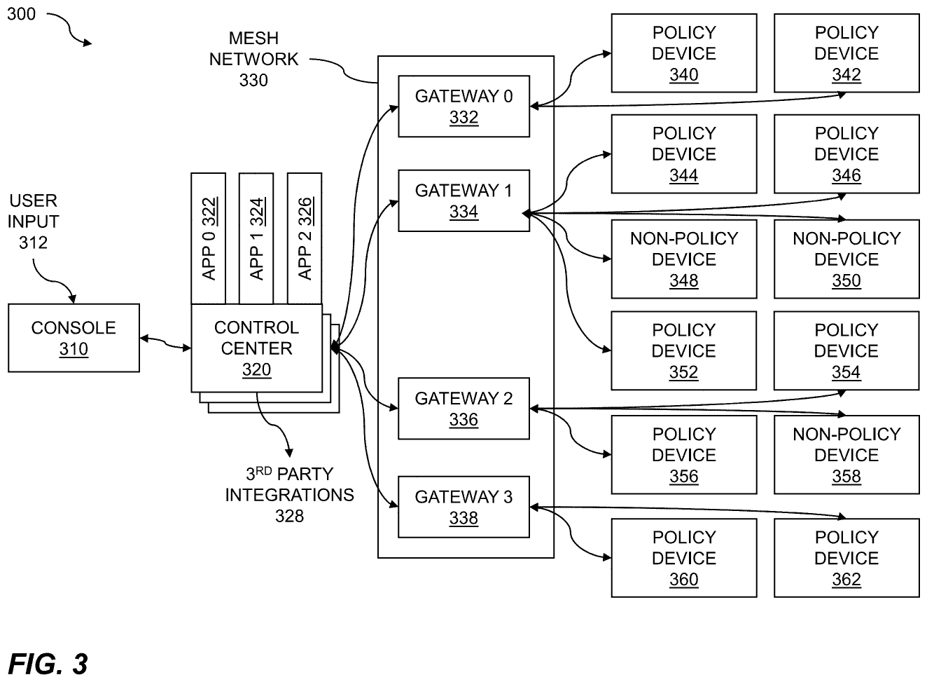

FIG. 3 shows a topology for datacenter power management. Discussed throughout, power management within a datacenter can be based on one or more power policies. A power policy can be chosen based on power requirements within the datacenter. The power requirements can further result from processing job mixes, seasonal influences such as increased or decreased cooling, and so on. The power policy, which oversees a datacenter topology, can be based on availability such as high-availability, service level agreements (SLAs), etc. The topology for datacenter power management is enabled using an edge mediation block. A datacenter power policy is deployed to a centralized power management platform, wherein the policy oversees a datacenter topology that includes one or more energy control blocks, wherein each of the one or more energy control blocks comprises an energy control block coupled to one or more datacenter loads. A power control gateway is coupled between the centralized power management platform and the one or more of energy control blocks, wherein the power control gateway comprises one gateway element for each of the one or more energy control blocks. Power distribution to the one or more datacenter loads is controlled using inter-gateway element information distributed among each gateway element.

A topology for datacenter power management is shown 300. The topology can include a console 310. The console can include a physical terminal, where the physical terminal can be located within or adjacent to a datacenter. The console can include a webpage; a webapp; an app on a device such as a computer, smartphone, tablet, or PDA; a dashboard; and the like. The control center can comprise a centralized power management platform. The console can enable user input 312, where the user can provide input through the terminal, webpage, webapp, app, etc. The console can further provide summarized sensor data, abstracted data, datacenter operational data, etc., to the user. The datacenter power management topology can include a control center 320. The control center can receive a datacenter power policy. The policy can be uploaded by the user, downloaded over a computer network, and so on. The control center can further communicate the policy to one or more energy control blocks within the datacenter. The policy, which oversees a datacenter topology, can configure the one or more energy control blocks. The control center can confirm that the one or more energy control blocks have accepted the policy. The control center can access one or more applications. The applications can include app 0 322, app 1 324, app 2 326, and so on. While three applications are shown, other numbers of applications can be accessed by the control center. The applications can include applications for configuration, control, operation, maintenance, etc., of the datacenter. The control center can couple to third party integrations 328. The third party integrations can include heating, ventilation, and air conditioning (HVAC) tools, networking and communication tools, data backup tools, and the like.

The control center 320 can be in communication with one or more gateways. The one or more gateways (discussed below) can be coupled between a centralized power management platform such as the control center and one or more energy control blocks. In embodiments, each element of the one or more power control gateways can be interconnected using a mesh network 330. The mesh network can include an ad hoc network, where the ad hoc network can include a wired, wireless, or hybrid network. The mesh network can provide a plurality of communications paths between or among components of the power control gateways, the centralized power management platform, and so on. In embodiments, the mesh network can enable each element of a power control gateway to communicate with each other element of the power control gateway independently from the centralized power management platform. In the example topology for datacenter power management, four gateways are shown including gateway 0 332, gateway 1 334, gateway 2 336, and gateway 3 338. While four gateways are shown, other numbers of gateways can be used.

Each gateway can be coupled to one or more devices. In embodiments, the devices or loads can include servers in a rack-mounted datacenter topology. The devices can include “policy devices” and “non-policy devices”. A policy device can include a device which can be managed using the control center. Management of the device can include configuring the device where the configuring can include providing software to a software-defined device. Management of the device can further include security of the device, availability of the device, clustering or de-clustering the device, and the like. A non-policy device can include a device, such as a device from a third party vendor, that may not be managed by the control center. The non-policy device can be configured, managed, enabled, disabled, etc., independently from other devices, although not necessarily by the control center. In the example topology, gateway 0 can be coupled to policy device 340 and policy device 342. The coupling between gateways and one or more devices can be bidirectional. Gateway 1 can be coupled to policy device 344, policy device 346, non-policy device 348, non-policy device 350, and policy device 352. Gateway 2 can be coupled to policy device 354, policy device 356, and non-policy device 358. Gateway 3 can be coupled to policy device 360 and policy device 362.

[start here with some description about functionality of the gateway that the devices do not have.]

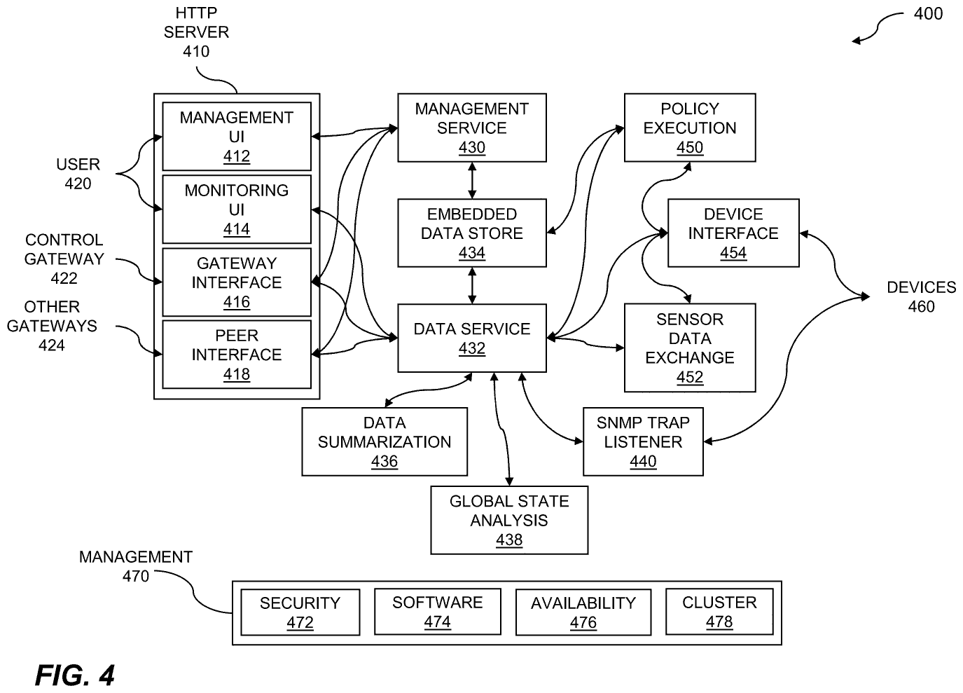

FIG. 4 illustrates a gateway functional architecture. A gateway functional architecture 400 comprises one or more of components that enable power policy execution, sensor data exchange, data summarization, state analysis including global state, and so on. The power control gateway can be used as an interface between a centralized power management platform and one or more power control blocks. The energy control blocks can be coupled to a variety of loads such as datacenter loads. The gateway can provide management services, data services, and so on, and can enable control of power to the datacenter loads. The gateway functional architecture enables datacenter power management with edge mediation block. A datacenter power policy is deployed to a centralized power management platform. A power control gateway is coupled between the centralized power management platform and the one or more of energy control blocks. Power distribution is controlled to the one or more datacenter loads using inter-gateway element information distributed among each gateway element.

The gateway functional architecture can include a communications server. In embodiments, the communications server can include a hypertext transfer protocol (HTTP) server 410. The HTTP server can include one or more user interfaces for management and monitoring, and can further include one or more interfaces such as gateway interfaces. In the gateway architecture example, the HTTP server can include a management user interface (UI) 412. The management UI can provide a user 420 with management screens, menus such as dropdown menus, radio buttons, dashboards, and so on. The management UI can enable the user to deploy a datacenter power policy by manually entering or altering a policy, uploading a policy, downloading a policy from a library of power policies, etc. The HTTP server can include a monitoring UI 414. The monitoring UI can enable the user to monitor some or all aspects of power management such as datacenter power management. The level of access to the monitoring can be controlled by a password, an access code, and identification (ID) number, and the like.

The gateway functional architecture can include a gateway interface 416. The gateway interface can provide an interface between a control gateway 422, which can be controlled by a platform such as a centralized power management platform, and the various components of the gateway. The gateway interface can transfer instructions or commands, data, topologies, sensor data, and so on. The gateway can provide a datacenter power policy where the policy oversees a datacenter topology that includes one or more energy control blocks. The energy control block can be coupled to loads, where the loads can include managed loads, unmanaged loads, hybrid loads, etc. The gateway functional architecture can include a peer interface 418. The peer interface can be used to provide communication between and among one or more other control gateways 424. The communications can be enabled using a network such as a mesh network. The mesh network can be self-configuring and can provide one or more communications paths to and from the one or more control gateways.

The HTTP server can be in communication with one or more components within the gateway functional architecture. The components with which the HTTP server can communicate can include a management service 430. The management service can accomplish a variety of management tasks. In embodiments, the management service can provide policy management. The policy management can include obtaining a policy, updating a policy, modifying a policy, and so on. In other embodiments, the management service can accomplish datacenter management. Datacenter management can include configuring a datacenter policy, configuring and monitoring energy control blocks, and so on. The datacenter management can include managing grid sources, battery systems, power caches, uninterruptable power supplies (UPS s), etc. The components with which the HTTP server communicates can include a data service 432. The data service can obtain data, process data, store data, and so on. The data can include configuration data, operating data, sensor data, etc. The management service and the data service can be in communication with a data store such as an embedded data store 434. The embedded store can be embedded within the gateway, coupled to the gateway, etc.

Discussed throughout, the data service can provide or access a variety of data processing and analyzing components. In the gateway functional architecture, the data service can be in communication with a data summarization component 436. The data summarization component can summarize data such as sensor data using techniques including arithmetic techniques, statistical techniques, and so on. In embodiments, sensor data from the one or more energy control blocks can be summarized. The sensor data can be based on load current requirements, load operating temperature, operating time, etc. The data service can be in communication with a global state analysis component 438. A global state can be based on two or more local states, where the local states can be associated with components, systems, modules, code, and so on. The local states, which comprise the global state, can be associated with a topology, energy control blocks, power control gates, other gateways, and so on. The global state can be based on physical time or time domain, and can indicate accumulated states of components associated with a centralized power management platform. In embodiments, the global state can be based on a causal domain.

The gateway functional architecture can include a simple network management protocol (SNMP) trap listener 440. An SNMP trap can include a message or notification from a component such as an energy control block. The SNMP trap can originate from a power load, a sensor, and so on. In embodiments, the SNMP trap can originate from a device 460 (discussed below), where a device can include a power source, a power load, a switch or smart switch, a power cache, a UPS, a power distribution unit (PDU), etc. An SNMP trap can occur when an agent such as an energy control block or device sends an asynchronous notification to a manager such as a gateway or power management platform. The asynchronous notification from the agent can occur between regular requests initiated by the manager. The SNMP trap is used by the agent to notify the agent that a significant event has occurred. A significant event can include insufficient power available for a load, load failure, load unresponsive, etc. Other message notification protocols can be included beside an SNMP trap. An HTTP webhook custom callback protocol could be implemented, for example, among other possible protocols.

The data service 432 and the embedded data store can be coupled to further components within the gateway functional architecture. In embodiments, the data service and the embedded data store can be coupled to a policy execution component 450. The policy execution component can execute a policy such as a datacenter policy, where executing the policy can oversee a datacenter topology. A datacenter topology can include power components such as power sources, switch blocks, smart switch blocks, power caches, UPSs, energy control blocks, and so on. Executing the policy can include configuring the power components to provide power to the power loads. The data service can be further coupled to a sensor data exchange component 452. The sensor data exchange component can capture sensor data from a device or energy control block and provide that data to the data service. The data service can receive the sensor data and perform operations on the data such as data summarization, global state analysis, and so on. In embodiments, sensor data from the one or more energy control blocks can be summarized. The summarization can include arithmetic operations, statistical operations, etc. The summarized sensor data can be forwarded upstream or downstream from the gateway. In embodiments, the sensor data that is summarized can be forwarded (upstream) to the centralized power management platform. The centralized power management platform can use the summarized data to analyze performance of a datacenter power policy, to modify or replace the policy, etc. In other embodiments, the sensor data that is summarized can be forwarded (downstream) to the one or more energy control blocks. The summarized sensor data can be used by the energy control block to store power in a power cache, draw power from a power cache, change power sources, and so on.

The data service 432, the policy execution component 450, and the sensor data exchange 452 can be in communication with a device interface 454. The device interface can be used to transfer data, status, control, topologies, and so on, between or among components of the gateway functional architecture and one or more devices 460. The devices can include energy control blocks, where the energy control blocks can be coupled to power loads such as power loads within a datacenter. The gateway functional architecture can include a management component 470. The management component can be used to manage the gateway, where management of the gateway can include securing the gateway, updating the gateway, configuring the gateway, enabling or disabling device controlled by the gateway, and so on. In embodiments, the management can include security management 472. The security management can include requiring credentials from a user, from a gateway, from a device, and so on, in order to obtain access to a gateway. The security can be enabled using identification such as a user name or number, an access control list (ACL), a code or key, and the like. The security can be based on an Internet protocol (IP) address, a port number, etc. In other embodiments, the management can include software management 474. The software can be used to configure the gateway, update the gateway, control the gateway, etc. The management can further include availability management 476. Availability management can be associated with one or more devices such as devices 460. The devices can include managed devices, where the managed devices can be controlled, configured, etc., by the centralized power management platform. The devices can include “unmanaged” devices, where the devices can be managed locally rather than by the centralized power management platform. Availability can include enabling or disabling a device, swapping in a spare device to replace a device that has failed or is going offline for maintenance, etc. In other embodiments, the availability management can include management of high-availability devices. In embodiments, the management can include cluster management 478. A cluster can include a cluster of managed and unmanaged devices, a cluster of gateways, and so on. Recall that gateways can connect and maintain communication with peer gateways throughout a center such as a datacenter using a mesh network. Cluster management can include using the gateway and the mesh network to take over management of one or more gateways within the mesh network that become unavailable.

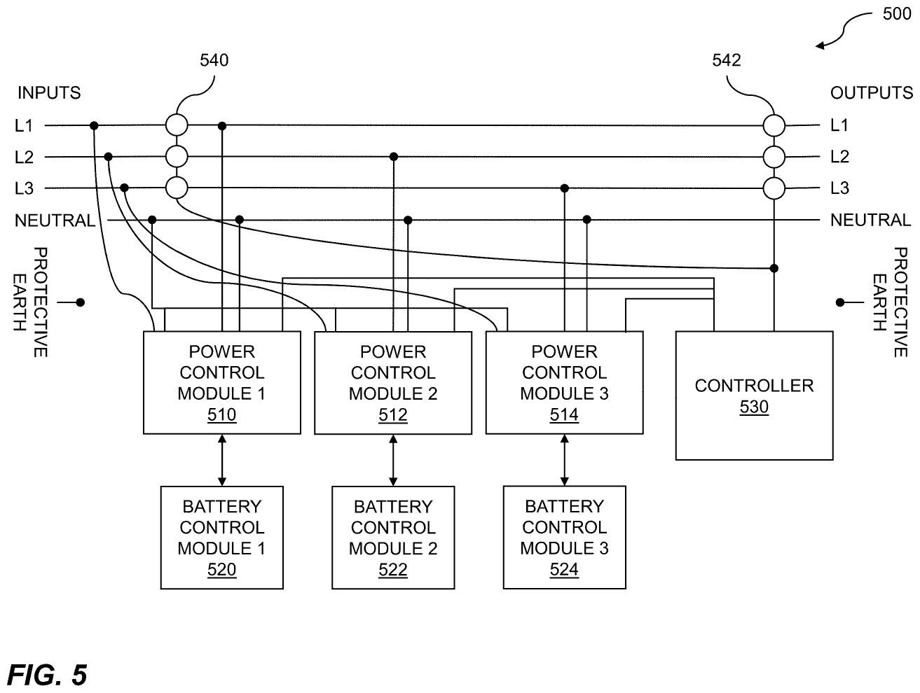

FIG. 5 shows a system for datacenter current injection. The system 500 is a block diagram for power control module usage. One or more power control modules can be used to convert or to store excess power, where the stored excess power can be used to meet an AC current requirement that can be in excess of available power. Power control module usage enables datacenter power management with edge mediation block. A datacenter power policy is deployed to a centralized power management platform. A power control gateway is coupled between the centralized power management platform and the one or more of energy control blocks. Power distribution to the one or more datacenter loads is controlled using inter-gateway element information distributed among each gateway element. Power control modules, such as power control module 1 510, power control module 2 512, and power control module 3 514, can be coupled to one or more phases of input power. In the example shown, input three-phase power is presented. The one or more power control modules further can be coupled to neutral and protective earth. The one or more control modules can be coupled to one or more battery control modules such as battery control module 1 520 coupled to power control module 1, battery control module 2 522 coupled to power control module 2, battery control module 3 524 coupled to power control module 3, and so on. Battery control modules are also parallelable in order to create a range of energy storage capacity options for any given power capacity associated with a power control module. A power control module and a battery control module can comprise a power control block. The power control module can further include one or more sensors.

The one or more power control modules can be controlled by a controller 530. The controller can monitor current at the line inputs using one or more current sensors such as current sensor 540. The controller can control storage of available AC power from the line inputs within batteries or capacitors; conversion of AC power to DC power; DC power conversion to AC power using injection of AC current into an output power system; and so on. The controller can monitor an amount of AC current in an output network using one or more current sensors, such as current sensor 542. Current sensors can be included within physical boundaries of the unit represented by block diagram 500, or they can be moved external to the physical boundaries, to support primary and auxiliary unit functionality. In embodiments, the AC current that can be injected by the one or more power control blocks can be sourced by at least one of the one or more power caches. A power cache can include one or more batteries, one or more capacitors, one or more supercapacitors, and so on, as part of the battery control modules 520, 522, and 524. The power control blocks can be managed or controlled by the datacenter power policy, where the datacenter power policy can be issued to individual hardware components within a datacenter topology. The power control module block diagram 500 can describe elements of an energy block for use in datacenter power management.

Each power control module of the system 500 can include a battery charging unit and a current mode grid tie inverter unit. The current mode grid tie inverter unit can enable current injection into a phase of the three-phase datacenter power grid at a constant voltage for the phase. The current mode grid tie inverter unit can enable current injection into a phase of the three-phase datacenter power grid at an in-phase AC frequency for the phase. The current mode grid tie inverter unit can inject current using pulse width modulation control. The pulse width modulation can be used to condition energy from the battery modules. The battery charging unit of power control modules 510, 512, and 514 can be an integrated form of battery control modules 510, 522, and 524, respectively, such that power control modules and/or battery control modules and/or power caches can be packaged in a discrete unit. Alternatively, the battery control modules can include the power caches, or they can be separately packaged. The battery modules can source energy for the power control modules.

The datacenter power management apparatus can enable power bursting within the datacenter. Power bursting is needed when either instantaneous load current requirements and/or instantaneous power grid source current availability cannot be met by a typical datacenter power topology. The inability can be based on latencies, impedances, current limits, and so on. The controller 530 can manage operational modes for the datacenter power management apparatus, including modes for enabling power bursting, SLA fulfillment, redundancy requirements, etc. The operational modes can include charging and energy injection. The operational modes can be determined by a datacenter power management policy. The datacenter power management policy can enable power supply redundancy within the datacenter. The datacenter power management apparatus can be colocated with datacenter loads, and the collocation can be within a datacenter rack.

The power control modules can include communication signal inputs coupled to the controller 530. The communication signal inputs can enable datacenter power policy execution. The controller 530 can provide real-time or near-real-time response to current sense points 540 or 542, whereas an overall datacenter processor running an overall datacenter policy may not be able to respond in real time due to processor and communication latencies.

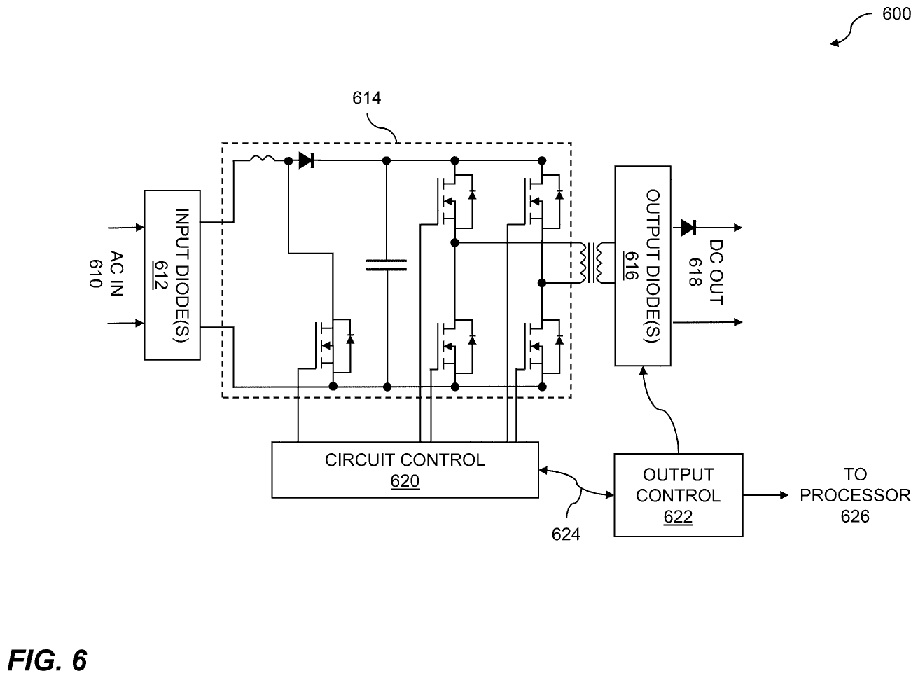

FIG. 6 is a block diagram for a charger. A power control block can store energy when excess energy is available, and can source energy when energy is required to meet a detected AC current requirement. The power control block can enable datacenter power management. Excess energy can be available for harvesting when the amount of energy available exceeds the amount of energy required to meet load demand at a given time (dI/dt). The excess energy harvesting technique enables capture of the excess energy for later use. The energy that is captured by energy harvesting can include excess AC current. In order the store the excess AC current, the excess AC power can be converted to DC power, where the DC power can be stored as energy in a DC storage cache. The DC energy can be stored using other storage technologies such as batteries, capacitors or supercapacitors, and so on. The capturing and storing of the excess AC energy support datacenter power management with edge mediation block. A datacenter power policy is deployed to a centralized power management platform. A power control gateway is coupled between the centralized power management platform and the one or more energy control blocks. Power distribution to the one or more datacenter loads is controlled using inter-gateway element information distributed among each gateway element.

Energy can be stored in batteries, capacitors, and so on, by charging the batteries or capacitors. A block diagram for a charger is shown 600. An AC input, such as a 120 VAC signal, can be provided at an input 610 to the charger. The input signal can be rectified using input diodes 612. The rectified signal can be applied to a charger circuit 614. The charger circuit can be controlled by circuit control 620. The circuit control can be used to monitor current, voltage, temperature, and so on for the charger circuit; to monitor current or voltage being provided to storage batteries or capacitors; to monitor charge state or temperature of the batteries or capacitors; and the like. The voltage or current generated by the charger circuit can be coupled to output diodes 616 through a transformer. The output from the output diodes, DC output 618, can be used to charge storage batteries, storage capacitors, etc. The output of the charger can be controlled by output control 622. The output control, which can be coupled 624 to the circuit control, can be used to control charging of one or more types of batteries, capacitors, etc. In a usage example, the output control can provide constant current during initial charging, then can provide constant voltage after a charge level threshold has been attained. The output control can be used to monitor the battery, thereby preventing damage to or catastrophic failure of the battery. Such battery management can also provide a safer use environment for the battery and/or an extended battery lifetime, among other benefits. The circuit control and the output control can be coupled to a processor 626. The processor can include a PC, a microprocessor, a microcontroller, and so on.

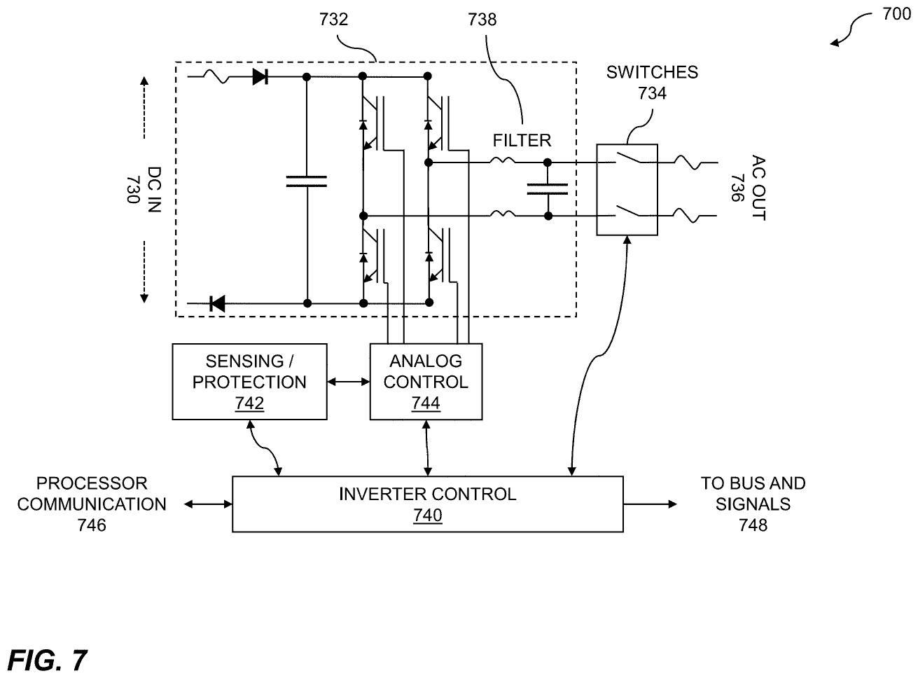

FIG. 7 is a block diagram for a single-phase inverter. Power can be injected by one or more power control blocks into a network such as the output network of a UPS. Discussed throughout, the power control blocks, the power caches, or the battery control modules can store energy collected when power capacity is greater than load demand and can provide energy based on a detected AC current requirement. One or more single-phase inverters can support datacenter power management with edge mediation block. A single-phase inverter block diagram is shown 700, where the single-phase inverter can be used to generate an AC output based on stored energy. The stored energy, which can be stored in batteries, capacitors, and so on, can be used to provide a DC input 730 to an inverter circuit 732. The inverter circuit can be coupled to switches 734, breakers, smart breakers, and so on, where the switches can be used to couple the output of the inverter to an AC output 736. The AC output voltage 736 is set by the constant voltage, constant frequency output of the UPS system or other power source. The DC input voltage is greater than the peak magnitude of AC source voltage. The inverter control techniques and the output filter convert the inverter output to an AC current in phase with and with the same frequency as the source voltage using pulse width modulation techniques. The resulting current injection transfers power to the power system at the connection point without disturbing the constant voltage, constant frequency characteristics. The inverter can be controlled by an inverter controller 740. The inverter controller can perform sensing and protection 742 such as over or under voltage of the DC input, presence of a DC input voltage, over current of the AC output, and the like. The inverter controller can operate analog control 744 of the inverter. The inverter controller can communicate with a processor 746. The processor, which can include a PC, a microprocessor, etc., can be used to apply a datacenter power policy. The inverter can be coupled to a bus or to signals 748, where the bus can include a bus within a data rack, between data racks, etc. The signals can include control signals, operating values, and the like. In embodiments, three single-phase inverters such as 700 can be applied to injection of AC current into three-phase AC power. A filter 738 is shown before switches 734 and output 736, which includes series inductors and a capacitor between the output lines. This filter can be used in conjunction with the PWM waveform applied to the DC voltage, as described in this section. The output impedance of circuit 732 allows a source voltage to exist on the output side of the circuit while current is flowing through the output. This output point is held at a constant voltage by the source, and the injected current is in phase with the voltage. The constant voltage of the output point and the in-phase injected current result in less current being required by the source to supply the load, and hence less power demand.

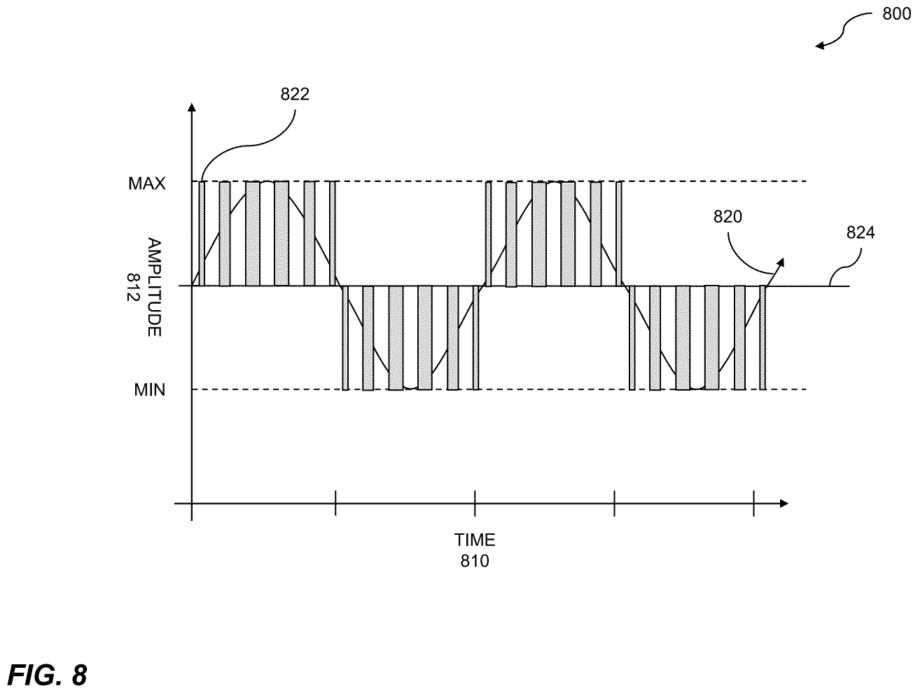

FIG. 8 illustrates pulse width modulation (PWM) of a sinusoid. Waveforms such as sinusoids, ramps, squares, sawteeth, etc., can be synthesized using various techniques. One or more techniques for generating a sinusoid or other waveform can be chosen based on various characteristics of the sinusoid such as frequency, noise tolerance, amplitude, tunability, synchronization with another sinusoid, and so on. By extension, a sinusoidal or AC voltage can be generated from a DC voltage using one or more techniques that can synthesize or reconstruct the AC voltage from the DC voltage. In embodiments, a sinusoid can be generated using pulse-width modulation (PWM) 800. Using PWM to synthesize an AC voltage from a DC voltage enables datacenter current power management with edge mediation block. A datacenter power policy is deployed to a centralized power management platform, where the policy oversees a datacenter topology that includes one or more energy control blocks, where each of the one or more energy control blocks comprises an energy control block coupled to one or more datacenter loads. A power control gateway is coupled between the centralized power management platform and the one or more energy control blocks, where the power control gateway comprises one gateway element for each of the one or more energy control blocks. Power distribution to the one or more datacenter loads is controlled using inter-gateway element information distributed among each gateway element.

Pulse-width modulation of a sinusoid is shown. PWM can represent a sinusoid or other waveform with pulses of varying durations, frequencies, and duty cycles. The amplitudes of the pulses can be equal. The pulses can be realized by opening and closing a switch between an input and an output. As the sinusoid is represented by a sequence of pulses, the average power delivered to the load or output can be reduced. The amplitude 812 of a sinusoid 820 is plotted versus time 810. A sequence of pulses, such as pulse 822, can be generated. A narrow pulse such as pulse 822 can represent a low current, a medium width pulse can represent an intermediate current, a wide pulse can represent a high current, and so on. Pulses with amplitudes greater than, or more positive with respect to the center line 824, can represent a “positive” portion of the sinusoidal waveform, while pulses with amplitudes less than, or more negative with respect to the center line, can represent a “negative” portion of the sinusoidal waveform. The process can be performed in a constant RMS voltage circuit controlled by the source, and the stored energy voltage can be greater than the peak magnitude of the voltage waveform at the point of the current injection connection. The result is a current flow into the injection point. The PWM as illustrated in FIG. 8 is viewed at the output of the inverter. The connection point is a filtered sinusoidal current and the C-V characteristic of the connection point is not disturbed. A filter component can create a tuned impedance that prevents the source voltage from being affected as the current is injected. The result of the current injection is Power (P), which is defined by the product of the source voltage and the injected current. The load is not affected. The source power is reduced proportionately to the magnitude of the injected current.

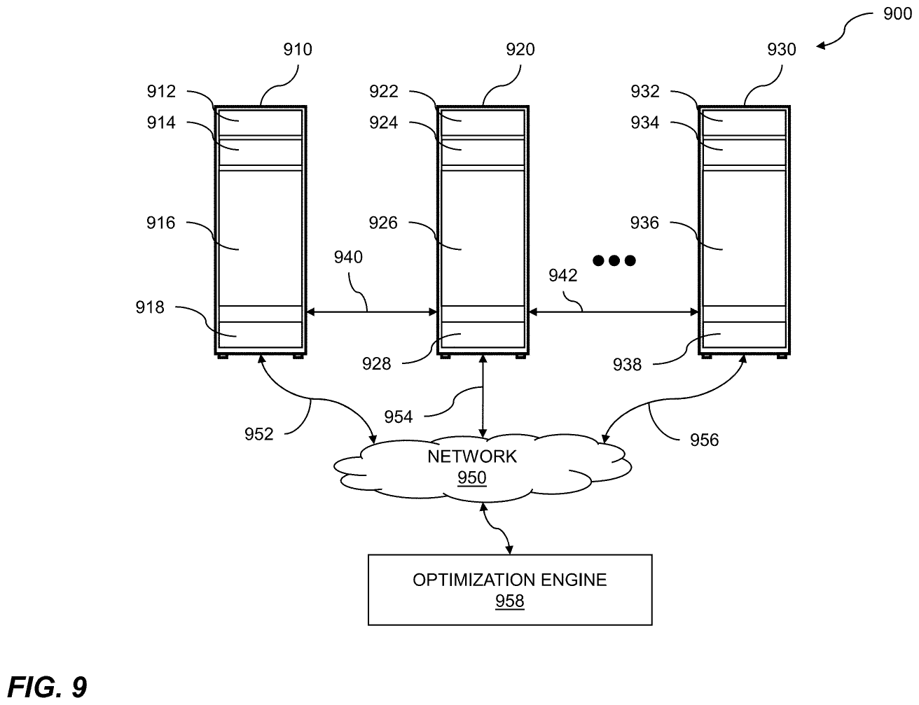

FIG. 9 shows a datacenter rack configuration. Data racks, also called information technology (IT) racks, contain a variety of electrical equipment components to which power is controlled. A datacenter can include multiple data racks to which management power is provided. Power management includes datacenter power management with edge mediation block. A datacenter power policy is deployed to a centralized power management platform, where the policy oversees a datacenter topology that includes one or more energy control blocks, where each of the one or more energy control blocks comprises an energy control block coupled to one or more datacenter loads. The power policy oversees a datacenter topology that may include at least one utility grid feed, one or more power caches, one or more power control blocks, one or more loads, and one or more uninterruptible power supplies (UPSs) providing AC power. A power control gateway is coupled between the centralized power management platform and the one or more energy control blocks, where the power control gateway comprises one gateway element for each of the one or more energy control blocks. Power distribution to the one or more datacenter loads is controlled using inter-gateway element information distributed among each gateway element.

A datacenter can include multiple data or IT racks. Example 900 includes three data racks, indicated as rack 910, rack 920, and rack 930. While three data racks are shown in example 900, in practice, there can be more or fewer data racks. The data rack 910 includes a power cache 912, a first server 914, a second server 916, and a power supply 918. The power supply 918 can be used for AC-DC conversion and/or filtering of power to be used by the servers 914 and 916, as well as replenishment of the power cache 912. In embodiments, the power cache 912 includes an array of rechargeable batteries. In embodiments, the batteries include, but are not limited to, lead-acid, nickel metal hydride, lithium ion, nickel cadmium, and/or lithium ion polymer batteries. Similarly, the data rack 920 includes a power cache 922, a first server 924, a second server 926, and a power supply 928. Furthermore, the data rack 930 includes a power cache 932, a first server 934, a second server 936, and a power supply 938. The data racks are interconnected by communication links 940 and 942. The communication links can be part of a local area network (LAN). In embodiments, the communication links include a wired Ethernet, Gigabit Ethernet, or another suitable communication link. The communication links enable each data rack to send and/or broadcast current power usage, operating conditions, and/or estimated power requirements to other data racks and/or upstream controllers such as a cluster controller. Thus, in the example 900, a power cache can be located on each of the multiple data racks within the datacenter. In embodiments, the power cache includes multiple batteries spread across the multiple data racks.

Each rack may be connected to a communication network 950. Rack 910 is connected to network 950 via communication link 952. Rack 920 is connected to network 950 via communication link 954. Rack 930 is connected to network 950 via communication link 956. The optimization engine 958 can retrieve operating parameters from each rack. In embodiments, the operating parameters are retrieved via SNMP (Simple Network Management Protocol), TR069, or another suitable protocol for reading information. Within a Management Information Base (MIB), various Object Identifiers (OIDs) may be defined for parameters such as instantaneous power consumption, average power consumption, number of cores in use, number of applications currently executing on a server, the mode of each application (suspended, running, etc.), internal temperature of each server and/or hard disk, and fan speed. Other parameters may also be represented within the MIB. Using the information from the MIB, the optimization engine 958 may derive a new dispatch strategy in order to achieve a power management goal. Thus, embodiments include performing the optimizing with an optimization engine. Other power system deployments supported by energy blocks can include power shelves used in alternate open source rack standards, small footprint parallel connected blocks in dedicated racks housing switch gear, and even applications beyond datacenters—wherever mission critical power systems have unused redundant capacity, and so on.

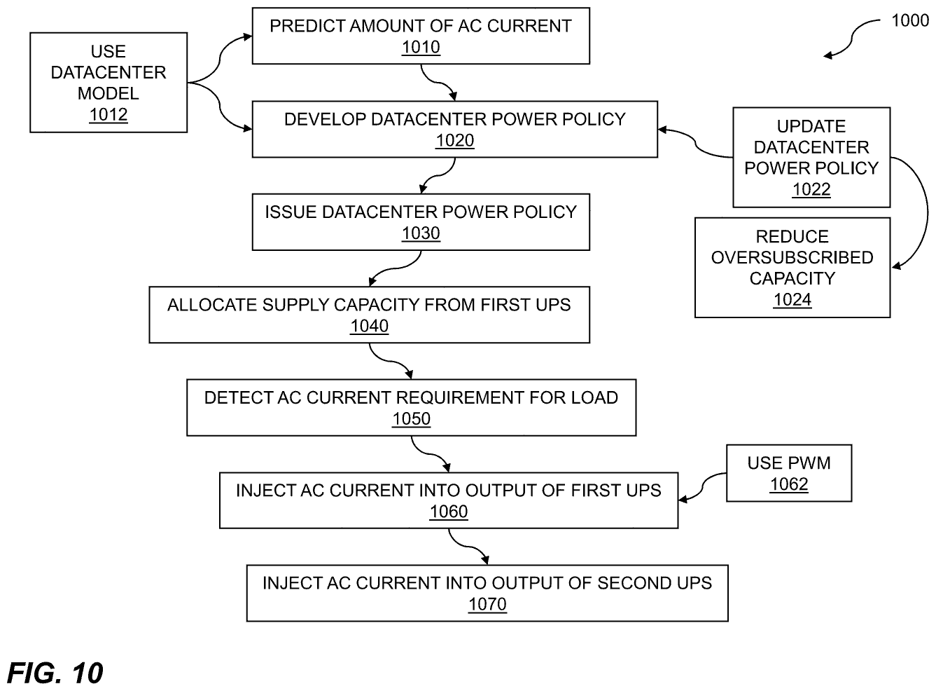

FIG. 10 is a flow diagram for datacenter power management using current injection. The current injection described in the flow 1000 can enable datacenter power management with edge mediation block. The amount and type of power provided to IT equipment within a datacenter can be based on contractual agreements, available power sources, available backup power sources, job mix, job scheduling, and so on. The flow 1000 shows a computer-implemented method for power management. The flow 1000 includes predicting an amount of AC current 1010 for injecting into the output network. The predicting can be based on data, where the data can include collected usage data, historical data, anticipated usage requirements or estimations, and so on. In embodiments, the predicting can be performed using a software-based datacenter model 1012. The software-based datacenter model can include a predictive model for current usages by equipment throughout the datacenter. The predictive model can include a power prediction model, where the power prediction model can include predicted power usage and a power correlation model. The power prediction model can be used to predict power usage requirements by the IT and electrical equipment at a time subsequent to the time at which the prediction model was calculated. The power prediction model can be updated, changed, replaced, refined, and so on, by correlating predicted power usage with measured power usage.

The flow 1000 includes developing a datacenter power policy 1020. The datacenter power policy can include the datacenter model. The datacenter power policy oversees a datacenter topology, where the datacenter topology can include power sources, power distribution, power loads, and the like. In embodiments, the one or more loads within the datacenter can be mission critical loads. The topology provides for the connection of power to one or more data racks within the datacenter. In embodiments, the topology can provide a series connection from a first UPS to two or more datacenter racks. Other connection strategies may also be used. In other embodiments, the topology can provide a parallel connection from the first UPS to two or more datacenter racks. The power sources can include utility power sources and local power feed components. The local power feed components can include locally generated power, power control blocks, power caches which can include batteries or capacitors, etc., switches or breakers, power distribution units, and so on. The local power feed components can include renewable power sources. In embodiments, the datacenter topology can include at least one utility grid feed, one or more power caches, one or more power control blocks, one or more loads, and one or more uninterruptible power supplies (UPSs) providing AC power. The datacenter topology can include power distribution and usage, power switching, power monitoring, etc. More than one datacenter power policy can be developed. In a usage example, a first datacenter power policy can be developed for normal or contracted operations, a second datacenter power policy can be developed for emergency operations, and so on. The datacenter power policy can be developed using software. The power policy software can interrogate various components of the datacenter topology, power sources and power loads, power caches, power control points, etc. Data collected by the interrogation can be analyzed to form the power policy.

The flow 1000 further includes updating the datacenter power policy 1022, based on additional source and load data. The updating the power policy can be based on analyzing data collected from power sources, power loads, etc. In embodiments, the updating can include reducing oversubscribed capacity 1024 within the datacenter. Data collected that relates to power usage based on actual loads can be used to reduce downward the allocated power capacity. In further embodiments, the updating can improve utilization, improve datacenter return on investment (ROI), etc. The updating can be accomplished periodically such as based on a schedule, opportunistically such as during an activity minimum within the datacenter, etc. In embodiments, the updating can be accomplished dynamically.

The flow 1000 includes issuing the datacenter power policy 1030 to individual hardware components within a datacenter topology. The issuing can be accomplished using wired or wireless communication techniques. The issuing the datacenter power policy can occur on a private network or other network within the datacenter. The issuing the datacenter power policy can include issuing the policy in an encrypted format. The issuing the policy can include issuing the policy to processing equipment, electrical equipment, switching equipment, and so on. In embodiments, the hardware components can include the one or more power control blocks. The issuing the policy can accomplish a variety of power management objectives. In embodiments, the issuing can enable the individual hardware components to inject current into the output network, based on the datacenter power policy. The injecting current is discussed shortly. The flow 1000 includes allocating a supply capacity from a first UPS 1040 to the one or more loads within the datacenter. The allocating the supply capacity can be based on an estimated load, a contracted load, a load based on historical load or usage data, and so on. The allocating the supply capacity can be based on a target value, a threshold, etc. In embodiments, the supply capacity is allocated below a peak load requirement for the one or more loads. The supply capacity is allocated based on the datacenter power policy. The flow 1000 includes detecting an AC current requirement 1050, by the one or more power control blocks, for the one or more loads at the output network of the first UPS. The detecting an AC current requirement can include an instantaneous current (dI/dt), an average current, an RMS current, a peak current, and the like. The detecting can be accomplished using one or more current detectors. The current detectors can be located within a main power panel, a remote power panel positioned adjacent to processing or electrical equipment, etc. In embodiments, a power control block provides data collection for power system current, voltage, and/or power.

The flow 1000 includes injecting AC current into the output network of the first UPS 1060. The output network of the first UPS 1060 comprises an upstream source for the datacenter node being supplied by the injecting AC current. The injecting can be accomplished by the one or more power control blocks. The injecting is based on the detecting and the datacenter power policy. The power control blocks can access energy stored in one or more power caches. The power caches can be based on various types of rechargeable components such as sealed lead acid (SLA) batteries, lithium iron phosphate (LiFePO4) batteries, etc. The power caches can be based on capacitors, supercapacitors, and the like. The injecting of AC current into the output network for the first UPS can be implemented using various techniques including modulation techniques. In embodiments, the injecting is controlled using pulse width modulation (PWM) 1062. The PWM can be accomplished using one or more circuit topologies. In embodiments, the pulse width modulation can be enabled by one or more current mode grid tie inverters. In embodiments, the current mode grid tie inverter unit injects current using pulse width modulation control. The PWM can be used to connect and disconnect one or more power caches. The width of a pulse can be modulated to change an amount of delivered average power. In embodiments, the pulse width modulation is used to control output of at least one of the one or more power caches. The injecting can be performed based on one or more parameters. In embodiments, the injecting does not disturb a voltage supplied by an upstream source. In embodiments, the injecting does not disturb a phase of AC frequency supplied by an upstream source. The power that is injected from the one or more power caches can be obtained using one or more techniques. In embodiments, the developing, allocating, detecting, and injecting can accomplish datacenter peak shaving. Peak shaving reduces the source power level for a period of time and may use stored energy from a cache, from a battery control module, and so on. Unused current can be defined as capacity that becomes available when peak shaving is not taking place and source power capacity exceeds load power demand. When peak shaving is not active, it becomes possible to store unallocated energy in a cache.

The flow 1000 further includes injecting AC current into the output network of a second UPS 1070 of the one or more UPSs. Note that a data rack within a datacenter can be connected to more than one power source. Many power supplies for processors, for example, come equipped with two power cords, one power cord to connect to a first power source and a second power cord to connect to a second power source. In embodiments, the second UPS can be sourced from a different utility grid source from the first UPS. By providing two power sources to the data rack, various management techniques can be implemented such as balancing loads between the two sources, providing a redundant power source in the event of a power source failure, and so on. In embodiments, the second UPS provides datacenter power redundancy. Various levels of power redundancy can be supported. The power redundancy can include 1N redundancy, where there are no spare power sources; 1N+1 redundancy, where there is one spare power source, 2N redundancy where there is a spare power source for each power source, and the like.

Embodiments of the flow 1000 include a processor-implemented method for datacenter power management comprising: providing a controller for a datacenter power infrastructure unit; coupling the controller to at least three power control modules, wherein at least one of the at least three power control modules is connected to each phase of a three-phase datacenter power grid; sensing current for each phase of the three-phase datacenter power grid, wherein at least three devices for sensing current are each coupled to the controller; and coupling at least three battery modules, wherein each battery module is coupled to a corresponding power control module, wherein the coupling provides an energy path between a battery module and each phase of the three-phase datacenter power grid, and wherein the coupling is managed by the controller. Various embodiments of the flow 1000 can be included in a computer program product embodied in a non-transitory computer readable medium that includes code executable by one or more processors.

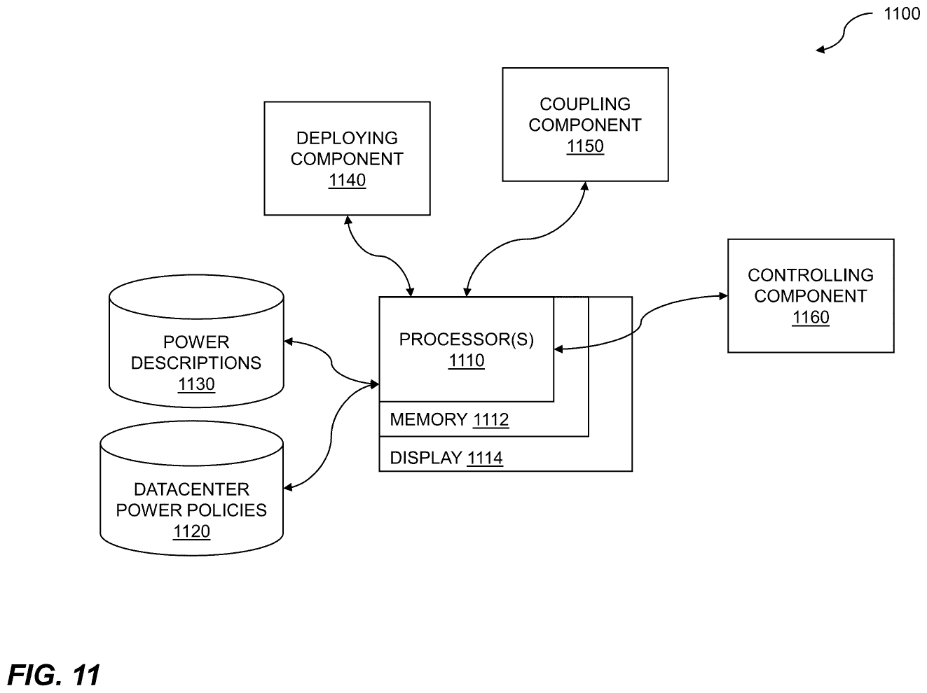

FIG. 11 is a system diagram for datacenter power management using edge mediation block. A datacenter power policy is deployed to a centralized power management platform, where the policy oversees a datacenter topology that includes one or more energy control blocks, where each of the one or more energy control blocks comprises an energy control block coupled to one or more datacenter loads. The datacenter topology can include at least one utility grid feed, one or more power caches, one or more power control blocks, one or more loads, and one or more uninterruptible power supplies (UPSs) providing AC power. A power control gateway is coupled between the centralized power management platform and the one or more of energy control blocks, where the power control gateway comprises one gateway element for each of the one or more energy control blocks. Power distribution to the one or more datacenter loads uses inter-gateway element information distributed among each gateway element.

The system 1100 can include one or more processors 1110 and a memory 1112 which stores instructions. The memory 1112 is coupled to the one or more processors 1110, wherein the one or more processors 1110 can execute instructions stored in the memory 1112. The memory 1112 can be used for storing instructions; for storing databases of power sources, power caches, and power loads; for storing information pertaining to load requirements or redundancy requirements; for storing power policies; for storing data collected from sensors; for storing service level agreements; for system support; and the like. Information regarding datacenter power management with edge mediation block can be shown on a display 1114 connected to the one or more processors 1110. The display can comprise a television monitor, a projector, a computer monitor (including a laptop screen, a tablet screen, a netbook screen, and the like), a smartphone display, a mobile device, or another electronic display.

The system 1100 includes datacenter power policies 1120. The datacenter power polices can include static power policies, dynamic power policies, service level agreements, and so on. In embodiments, the datacenter power policies 1120 are stored in a networked database, such as a structured query language (SQL) database. The datacenter power policies 1120 can include limits, such as power consumption limits, as well as switch configurations when certain conditions are met. For example, when conditions allow peak shaving to take place, and surplus power exists, the power policies can identify switches and their configurations, which allow replenishing of one or more power caches. In embodiments, the policy oversees a datacenter topology that includes one or more energy control blocks, where each of the one or more energy control blocks comprises an energy control block coupled to one or more datacenter loads. The system 1100 further includes a repository of power descriptions 1130. The power descriptions 1130 can include, but are not limited to, power descriptions of power loads, power caches, power supplies, rack power profiles, batteries, buses, circuit breakers, fuses, and the like. The power descriptions can include physical space needs, electrical equipment cooling requirements, etc.

The system 1100 can include a deploying component 1140. The deploying component 1140 can be used for deploying a datacenter power policy to a centralized power management platform. In embodiments, the centralized power management platform can include a software defined management platform. The centralized power management platform can monitor a power infrastructure, where the power infrastructure can be associated with a datacenter, a manufacturing facility, an industrial facility, or other power consumer. The centralized power management platform can further detect scenarios of power management risk or failure. The power management platform can mitigate the risk by deploying a datacenter policy, updating the policy, etc. The policy oversees a datacenter topology that includes one or more energy control blocks. The datacenter topology can include at least one utility grid feed, one or more power caches, one or more power control blocks, one or more loads, one or more uninterruptible power supplies (UPSs), and backup power sets such as diesel-generator sets, etc., that can provide AC power. The one or more uninterruptible power supplies can include distributed UPSs, where the distributed UPSs can include associated UPSs distributed throughout a facility such as a datacenter. The distributed UPSs can include UPS elements placed within data racks or IT racks. In embodiments, one or more of the UPSs can be replaced with one or more power caches. The datacenter power policy can be based on available power sources such as grid power, diesel-generator power, or alternative energy sources; battery backup capabilities; and so on. The datacenter power policy can be based on power source availability, power costs, contractual arrangements, etc.

The system 1100 includes a coupling component 1150. The coupling component 1150 is configured to couple a power control gateway between the centralized power management platform and the one or more of energy control blocks. The power control gateway can include mediation techniques which can be applied between power loads and the centralized power management platform. The power management gateway can handle communications protocols provided by power devices. The protocols are used to communicate information from the power devices. The protocols provided by the power devices can be abstracted into one or more standard protocols. In embodiments, the information that was abstracted can be forwarded using a hypertext transfer protocol (HTTP). The power control gateway is comprised of one or more components. In embodiments, the power control gateway can include one gateway element for each of the one or more energy control blocks.

The system 1100 includes a controlling component 1160. The controlling component 1160 can control power distribution to the one or more datacenter loads using inter-gateway element information distributed among each gateway element. The controlling power can be based on data collected from sensors, where the sensors can be associated with the energy control blocks, loads, power components, and so on. In embodiments, sensor data can be collected using a sensor data exchange component. Discussed throughout, sensor data from the one or more energy control blocks is summarized. The summarizing the sensor data can include collating, filtering, summing, or otherwise manipulating the sensor data. In embodiments, the sensor data that is summarized can be forwarded to the centralized power management platform. The forwarding of the summarized sensor data can be accomplished using a protocol such as HTTP, an HTTP-based protocol, and the like. The control can be based on collecting further information, where the further information can also be abstracted. Embodiments include abstracting, by the power control gateway, information from the one or more energy control blocks. The further information can be collected from various power components. In embodiments, the information that was abstracted can include energy control block form factor, sensor data, or non-policy-based energy control block identification. The controlling can be based on data associated with a power policy. Further embodiments include collecting sensor data and currently deployed policy data from at least one of the one or more energy control blocks.

Disclosed embodiments can include a computer program product embodied in a non-transitory computer readable medium for power management, the computer program product comprising code which causes one or more processors to perform operations of: deploying a datacenter power policy to a centralized power management platform, wherein the policy oversees a datacenter topology that includes one or more energy control blocks, wherein each of the one or more energy control blocks comprises an energy control block coupled to one or more datacenter loads; coupling a power control gateway between the centralized power management platform and the one or more of energy control blocks, wherein the power control gateway comprises one gateway element for each of the one or more energy control blocks; and controlling power distribution to the one or more datacenter loads using inter-gateway element information distributed among each gateway element.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited neither to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for power management comprising:
deploying a datacenter power policy to a centralized power management platform, wherein the policy oversees a datacenter topology that includes one or more energy control blocks, wherein each of the one or more energy control blocks comprises an energy control block coupled to one or more datacenter loads;
coupling a power control gateway between the centralized power management platform and the one or more of energy control blocks, wherein the power control gateway comprises one gateway element for each of the one or more energy control blocks; and
controlling power distribution to the one or more datacenter loads using inter-gateway element information distributed among each gateway element.

2. A computer program product embodied in a non-transitory computer readable medium for power management, the computer program product comprising code which causes one or more processors to perform operations of:
deploying a datacenter power policy to a centralized power management platform, wherein the policy oversees a datacenter topology that includes one or more energy control blocks, wherein each of the one or more energy control blocks comprises an energy control block coupled to one or more datacenter loads;
coupling a power control gateway between the centralized power management platform and the one or more of energy control blocks, wherein the power control gateway comprises one gateway element for each of the one or more energy control blocks; and
controlling power distribution to the one or more datacenter loads using inter-gateway element information distributed among each gateway element.

3. A computer system for power management comprising:
a memory which stores instructions;
one or more processors attached to the memory wherein the one or more processors, when executing the instructions which are stored, are configured to:
deploy a datacenter power policy to a centralized power management platform, wherein the policy oversees a datacenter topology that includes one or more energy control blocks, wherein each of the one or more energy control blocks comprises an energy control block coupled to one or more datacenter loads;
couple a power control gateway between the centralized power management platform and the one or more of energy control blocks, wherein the power control gateway comprises one gateway element for each of the one or more energy control blocks; and
control power distribution to the one or more datacenter loads using inter-gateway element information distributed among each gateway element.
